(19) United States
(12) Patent Application Publication
(10) Pub. No.: US 2020/0215653 A1
(43) Pub. Date: Jul. 9, 2020

(54) Sweeper Accessory for Use with a Pneumatic Chip Collector

(71) Applicant: INTER-SOURCE RECOVERY SYSTEMS, Kalamazoo, MI (US)

(72) Inventor: William D. Nemedi, Paw Paw, MI (US)

(21) Appl. No.: 16/242,510

(22) Filed: Jan. 8, 2019

(51) Int. Cl. B23Q 11/00; A47L 7/00; A47L 9/04

(52) U.S. Cl. CPC B23Q 11/0046; A47L 9/0466; A47L 7/0095; B23Q 11/0057

(57) ABSTRACT

A free-floating, sweeper head for use in a pneumatic chip collector system. The sweeper head includes a sweeper mechanism and a connector configured to be coupled to the pneumatic system. The sweeper head includes a horizontal plate, a skirt that extends transversely from the plate along a portion of a perimeter of the plate, and an aperture that extends through the plate and is in communication with the connector. The sweeper mechanism has a drive disposed on the plate, a set of blades disposed below the plate, and a shaft that operatively couples the drive and the set of blades. The skirt creates an opening below the plate that is adapted to receive at least one chip when the set of blades rotates.

### FIELD OF THE DISCLOSURE

The present disclosure generally relates to chip collectors and, more particularly, to an accessory for use in a chip collection system used to collect chips generated during machining operations.

### BACKGROUND

In the course of machining operations, scrap materials are generated. These scrap materials may be referred to generally as wet chips, or wet chip material, which material includes a solid component and a fluid (lubricant) component. This scrap material may be in the form of relatively small wet chips, also referred to as granular wet chips, stringy pieces of wet chips, and bales of wet chip material.

Conventionally, wet chip materials are conveyed from one or more machine stations to a centrifugal separator station where the wet chip material is centrifugally separated into dry chips and fluid. This is done so that the dry chips may be reclaimed, and the fluid reclaimed or sent for disposal. Many different conveyors or methods of conveyance are known, including pneumatic transport of the wet chip material from the machine stations to the centrifugal separator.

### SUMMARY

In one aspect, a free-floating, sweeper head for use with a pneumatic chip collector includes a sweeper mechanism and a connector configured to be coupled to a pneumatic system. The sweeper head has a horizontal plate, which includes a first surface and a second surface opposite the first surface, a skirt that extends transversely downward from the second surface of the plate along a portion of a perimeter of the plate, and an aperture that extends through the plate and is in communication with the connector. The sweeper mechanism has a drive that is disposed on the first surface of the plate, a set of blades disposed below the second surface of the plate, and a shaft operatively coupling the drive and the set of blades. The skirt creates an opening that is adapted to receive at least one chip when the set of blades rotates.

In a further aspect, a pneumatic chip collector system includes a vacuum generator coupled to a first end of a hose and is configured to create a negative pressure in the hose, and a free-floating, sweeper head coupled to a second end of the hose and includes a sweeper mechanism and a connector. The connector is configured to be coupled to the hose. The sweeper head has a horizontal plate, which includes a first surface and a second surface opposite the first surface, a skirt that extends transversely from the second surface of the plate along a portion of a perimeter of the plate, and an aperture that extends through the plate and is in communication with the connector. The sweeper mechanism has a drive that is disposed on the first surface of the plate, a set of blades disposed below the second surface of the plate, and a shaft operatively coupling the drive and the set of blades. The skirt creates an opening that is adapted to receive at least one chip when the set of blades rotates.

In still a further aspect, a method of collecting chips from a machining operation includes disposing a free-floating, sweeper head on a surface. The sweeper head includes a sweeper mechanism and a connector configured to be coupled to a pneumatic system. The sweeper head has a horizontal plate, which includes a first surface and a second surface opposite the first surface, a skirt that extends transversely from the second surface of the plate along a portion of a perimeter of the plate, and an aperture that extends through the plate and is in communication with the connector. The sweeper mechanism has a drive that is disposed on the first surface of the plate, a set of blades disposed below the second surface of the plate, and a shaft operatively coupling the drive and the set of blades. The method also includes rotating the set of blades via the drive such that at least one chip is received at the aperture through an opening created by the skirt. The method further includes generating a vacuum at the aperture and moving at least one of the sweeper head and the surface relative to the other.

### BRIEF DESCRIPTION OF THE DRAWINGS

It is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except what may be explicitly delineated in the corresponding written description. None of the drawings are necessarily to scale.

FIG. 1 is a perspective view of an example pneumatic chip collector system, constructed in accordance with the present disclosure.

FIG. 2 is a perspective view of an example sweeper head for a pneumatic chip collector, constructed in accordance with the present disclosure.

FIG. 3 is a perspective view of the example sweeper head of FIG. 1

FIG. 4 is a top view of the example sweeper head of FIG. 2.

FIG. 5 is a cross-sectional view of the sweeper head of FIG. 2.

FIG. 6 is a side view of an example set of blades for the sweeper head, constructed in accordance with the present disclosure.

FIG. 7 is a top view of another example set of blades for the sweeper head, constructed in accordance with the present disclosure.

FIG. 8 is a top view of yet another example set of blades for the sweeper head, constructed in accordance with the present disclosure.

FIG. 9 is a top view of an example set of blades for the sweeper head, constructed in accordance with the present disclosure.

FIG. 10 is a top view of another example set of blades for the sweeper head, constructed in accordance with the present disclosure.

FIG. 11 is a top view of yet another example set of blades for the sweeper head, constructed in accordance with the present disclosure.

FIG. 12 a top view of an example set of blades for the sweeper head, constructed in accordance with the present disclosure.

FIG. 13 is a side view of another example set of blades for the sweeper head, constructed in accordance with the present disclosure.

FIG. 14 is a side view of yet another example set of blades for the sweeper head, constructed in accordance with the present disclosure.

FIG. 15 is a perspective view of an example sweeper head for a pneumatic chip collector, constructed in accordance with the present disclosure.

### DETAILED DESCRIPTION

The present disclosure is generally directed to an accessory for use with a pneumatic chip collector. In particular, the present disclosure is generally directed to a free-floating, sweeper head used to collect chips from a machining operation. The disclosed sweeper head travels a working surface such as, for example, a bed of a mill, to collect, separate, and size stringy, nesty, matty type chips that are a byproduct of the machining operation. The sweeper head collects the chips and, with the use of a pneumatic system, vacuums the chips off of the working surface and transports the chips to another component of the pneumatic system for further processing.

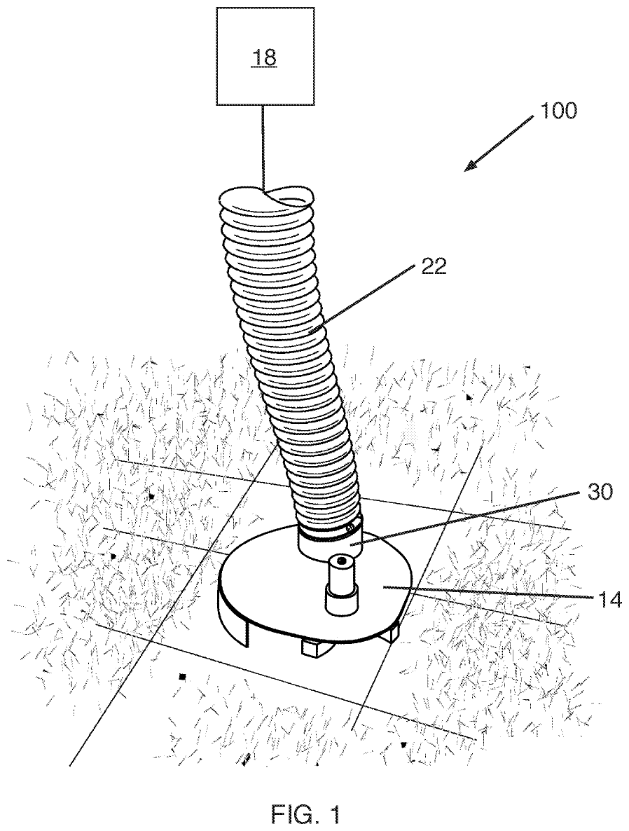

Referring now to FIG. 1, which illustrates an example of a pneumatic chip collector system 10. The system 10 includes a free-floating, sweeper head 14 connected to a vacuum generator 18 by a hose 22. The sweeper head 14 is free-floating in that it is not attached to a frame, except that it is tethered from above by the hose 22; that is, the sweeper head 14 may be coupled to the hose 22 and still remain free-floating relative to a working surface on which the sweeper head 14 rests. The vacuum generator 18, coupled to the sweeper head 14 by the hose 22, creates a negative pressure (or vacuum) in the hose 22 to transport chips from the work surface to other parts of the system 10 for further processing.

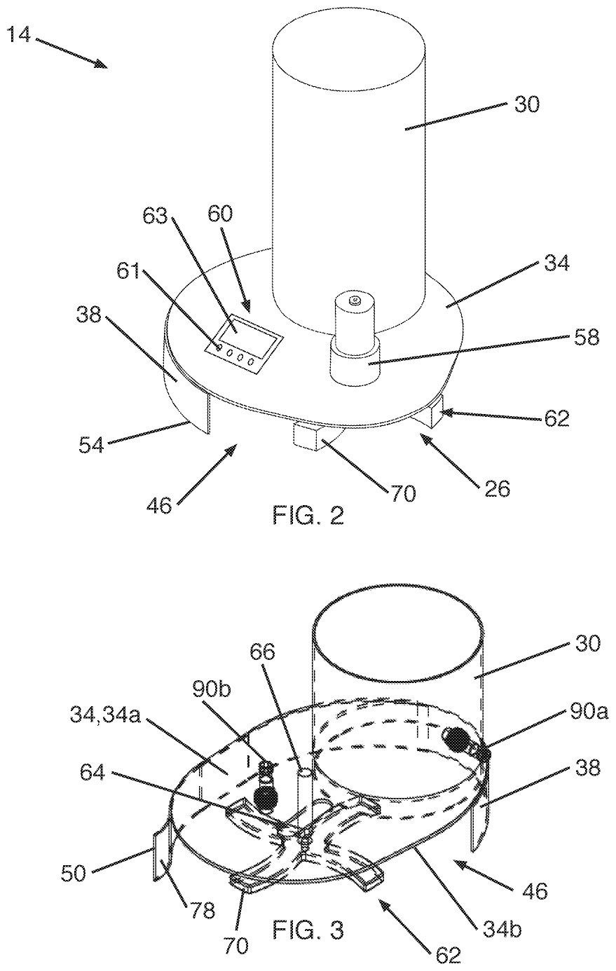

FIGS. 2-5 illustrate a first example of a free-floating, sweeper head 14 constructed in accordance with the disclosure. The sweeper head 14 generally includes a sweeper mechanism 26 and a connector 30 that is configured to couple the sweeper head 14 to the system 10. The connector 30 is a rigid tube disposed on a horizontal plate 34 and extends from the plate 34 to create a portion that receives a first end of the hose 22, shown in FIG. 1. The connector 30 may be coupled to the hose 22 by any mechanism capable of releasably and securely attaching the sweeper head 14 to the hose 22. For example, the connector 30 could be coupled to the hose 22 by a friction fit. In other examples, the connector 30 can have a threaded interior portion that threadably receives a threaded portion of the hose 22. In yet other examples, the connector 30 can be coupled to the hose 22 using a clamp such as, for example, a band clamp, a pipe clamp, a hose clamp, etc. However, in some examples, the hose 22 may be permanently fixed to the connector 30. In such an example, the sweeper head 14 would be fixedly attached to the hose 22 rather than a separate, removable element. In some examples, the sweeper head 14 can also include a rotary drive (not shown) that couples the sweeper head 14 to the hose 22. In particular, the rotary drive couples the connector 30 and the hose 22 such that the sweeper head 14 can rotate relative to the hose 22.

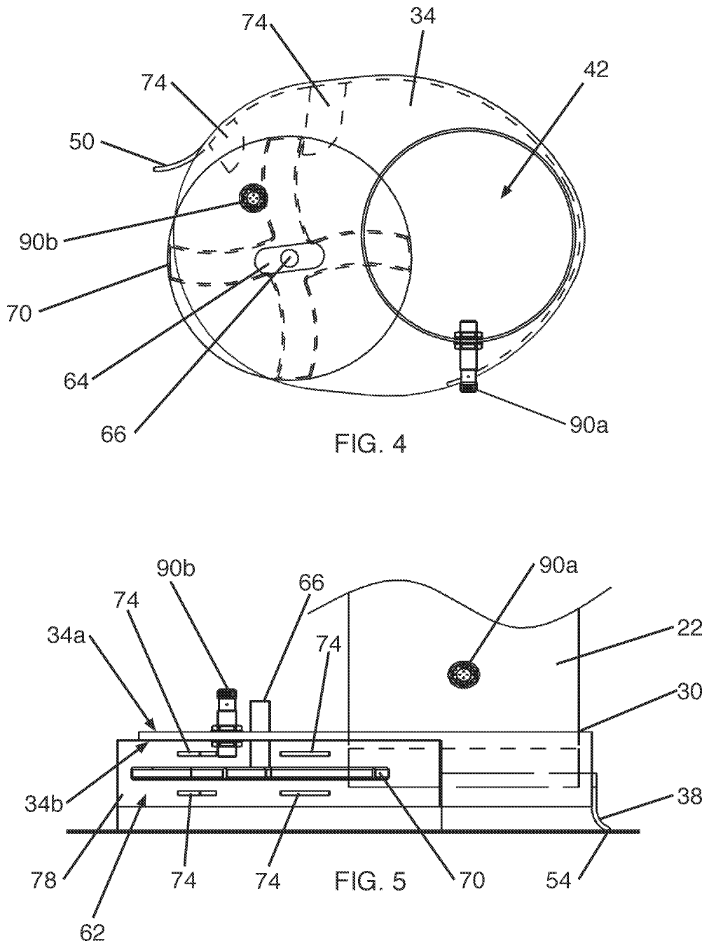

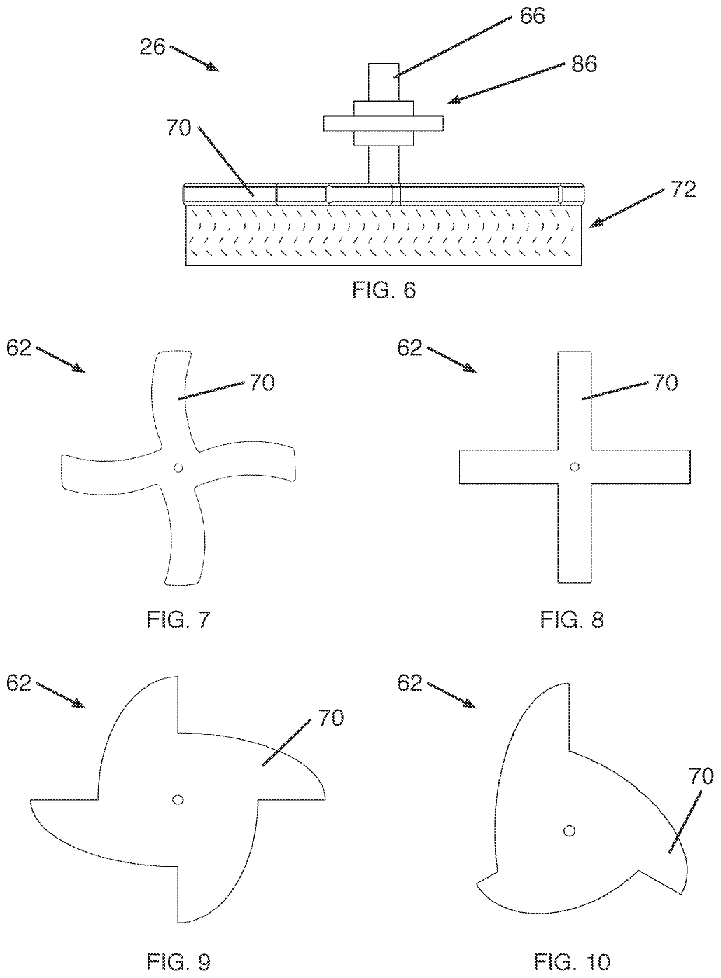

The sweeper head 14 includes the plate 34, a skirt 38 that extends transversely and generally downward from the plate 34, and an aperture 42 (shown in FIG. 4) that extends through the plate 34 and is in communication with the connector 30. In particular, as identified in FIG. 5, the plate 34 includes a first surface 34a, shown as a top surface, and a second surface 34b, shown as a bottom surface, that is opposite the first surface 34a. The plate 34 may take any shape depending on the environment in which the sweeper head 14 is used. For example, the plate 34 can take an oval or egg-like shape as illustrated in FIG. 2. In other examples, the plate 34 can take a substantially oval, or capsule like, shape as illustrated in FIGS. 3 and 4, or any other desirable shape including square, circle, polygonal, etc. The plate 34 may be made of any material that is suitable for use in the environment in which the sweeper head 14 is used. For example, the plate 34 can be made of a plastic or other light weight polymer. In other examples, the plate 34 can be made of a metal or other heavy-duty material. The plate 34 can be formed using any known manufacturing techniques. For example, the plate 34 can be formed through casting, extrusion, or simple sheet material forming and assembly. In other examples, the plate 34 can be formed using an additive manufacturing technique that involves adding layer upon successive layer of material, such as, three-dimensional printing.

The skirt 38 extends transversely downward from the plate 34 and, more particularly, the skirt 38 extends transversely downward from the second surface 34b of the plate 34 along a portion of a perimeter of the plate. In other examples, however, the skirt 38 can extend from a side edge of the plate 34 rather than the second surface 34b of the plate 34. As depicted in FIGS. 2-5, the skirt 38 extends along the portion of the perimeter and includes opposite terminal ends, between which the skirt 38 defines a perimeter opening 46 that is adapted to receive at least one chip when the set of blades 62 rotates. Thus, the skirt 38 creates a portion under the plate 34 that can retain the chips, which ensures the chips will be directed to the aperture 42. To that end, the skirt 38 may extend along any portion of the perimeter. For example, the skirt 38 can extend along the portion of the perimeter of the plate 34 that is proximate the aperture 42. Moreover, the skirt 38 may create any sized opening 46 depending on the use of the sweeper head 14, i.e., depending on the size of chips that are to pass through the opening 46. In some examples, the skirt 38 can create a smaller opening 46 that permits chips of smaller length and width. In other examples, the skirt 38 can create a substantial opening 46, as illustrated in the figures, which allows chips of various sizes to pass through the opening 46. In some versions, either or both of the terminal ends of the skirt 38 can be flanged 50, as depicted. In particular, the at least one terminal end is flanged 50 to extend beyond the perimeter of the plate 34 that is adjacent to the opening 46. The flanged end 50 may assist with directing chips in passing through the opening 46 by acting as a guide for the chips to follow to the opening 46.

The skirt 38 may be made of any material that is suitable for the environment in which the sweeper head 14 is used. For example, the skirt 38 can be made from the same material as the plate 34 or can be made from a different material than the plate 34. Additionally, the skirt 34 can, in some examples, be made from a flexible material that allows for all or a portion of a bottom 54 of the skirt 34 to deflect under compressive forces exerted on the skirt 38 by the plate 34 and the working surface as the sweeper head 14 is traveling, as depicted in FIG. 5. For example, the skirt 38 can be made from materials other than metal such as a polymer, an elastomer, and/or a composite material. In such an example, the entire skirt 38 can be made from the flexible material or, in other examples, a portion of the bottom 54 of the skirt 38 can be made from the flexible material while the remaining portion of the skirt 38 can be a rigid material. Further in some versions, the bottom 54 of the skirt 38 could be equipped with one or more additional features to assist with chip collection such as, for example, a brush type feature.

The aperture 42 and the connector 30 facilitate collection of the chips from below the plate 34 to the rest of the system 10 through the hose 22. In particular, the aperture 42 is in communication with the connector 30 by extending through the plate 34, i.e., from the first surface 34a to the second surface 34b or vice-a-versa. By virtue of being in communication with the connector 30 and, thus, the hose 22, a vacuum is created at the aperture 42 when the vacuum generator 18 creates a negative pressure in the hose. The aperture 42 is sized to be equal to the size of the connector 30. However, in some examples, the aperture 42 could be smaller or larger in diameter than the connector 30. Additionally, in some examples, the aperture 42 can be more than one aperture (not shown). In such an example, at least one aperture can extend through the plate 34 and be disposed on the plate such that all of the at least one aperture are disposed within a perimeter of the connector 30. The use of multiple apertures rather than one large aperture can act as a filter, which allows chips of a certain size to pass through the aperture while preventing other chips from passing through the aperture.

As discussed above, the sweeper head 14 includes the sweeper mechanism 26, which is carried by, and disposed on, the plate 34. The sweeper mechanism 26 includes a drive 58 that is disposed on the first surface 34a of the plate 34, a set of blades 62 that are disposed below the second surface 34b of the plate 34, and a shaft 66 that operatively couples the set of blades 62 to the drive 58. The sweeper mechanism 26 may be disposed anywhere on the plate 34, such that at least a portion of one or more blades 70 in the set of blades 62 extends past the perimeter of the plate 34 through the opening 46 when actuated by the drive 58. In one version, the sweeper mechanism 26 is disposed on the plate 34, such that the shaft 66 extends through a slot 64 in the plate 34. The slot 64 may take any shape that allows the position of the sweeper mechanism 26 to be adjusted relative to the plate 34. For example, the slot 64 can be an oval shaped slot, a capsule shaped slot, a triangular slot, a rectangular slot, etc. The shaft 66, and the sweeper mechanism 26, can slide within the slot 64 to adjust the position of the sweeper mechanism 26, and then locked in position with a fastener mechanism. Additionally, as shown, a central axis of the sweeper mechanism 26 is offset from a central axis of the of the aperture 42 such that when the blades 70 are rotated by the drive 58, the blades 70 draw chips from outside of the opening 46, under the plate 34, and to the aperture 42 for vacuum collection.

The drive 58 provides the rotational force necessary to rotate the shaft 66 and, therefore, the set of blades 62, such that the set of blades 62 is adapted to sweep chips in through the opening 46 and in close proximity to the aperture 42 for collection. The drive 58 may be any drive of adequate power that is capable of creating rotational motion depending on the specific application of the sweeper head 10. For example, the drive 58 can be a rotary drive such as an electric motor, a pneumatic drive, a hydraulic drive, etc. Specifically, in some examples, the drive 58 can be a direct current (“DC”) electric motor coupled to a variable frequency drive mounted on the sweeper head 14. The drive 58 is operated by a control module 60 that includes a programmable logic controller, which manages the drive 58 during operation of the sweeper head 14 in concert with the operation of the machining center or the mill. In particular, the control module may be disposed anywhere in the machining center or mill that allows the control module to be used safely. For example, the control module can be disposed on the sweeper head and include at least one button 61 and a user interface 63 (or, alternatively, a touch screen display). In such an example, the at least one button 61 (or, alternatively, the touch screen display) can be used to turn the sweeper mechanism 26 on and off, change the direction of rotation of the set of blades 62, as well as turn the vacuum generator 18 on and off. The user interface 63 (or, alternatively, the touch screen display) can display various operational parameters of the sweeper head 14 such as, for example, rotational speed of the set of blades 62, the air flow speed in the hose 22, an alert signaling the set of blades 62 jammed, an alert signaling an issue with the drive 58, the set of blades 62, etc. In other examples, the control module 60 can be disposed on a stationary surface proximate the sweeper head 14. In such an example, the control module 60 can be communicatively coupled to the sweeper head 14, and thus the drive 58, via a hardwired or wireless connection.

Once turned on, the sweeper head 14 may not be in continuous operation. In particular, the drive 58 may cause the shaft 66, and thus the set of blades 62, to rotate immediately upon the sweeper head 14 being turned on. However, in other examples, the drive 58 can begin in a neutral position such that the set of blades 62 do not begin to rotate once the sweeper head 14 is turned on. The drive 58 can begin rotating the set of blades 62, for example, after a predetermined amount of time once the sweeper head 14 is turned on, manually through the control module 60, or automatically via a proximity sensor. Additionally, in other examples, the control module 60 can cause the drive 58 to rotate the set of blades 62 clockwise or counterclockwise in response to the direction of movement of the sweeper head 14.

The set of blades 62 is disposed below the second surface 34b of the plate 34, such that the height of the set of blades 62, relative to the bottom 54 of the skirt, is adjustable. In particular, the set of blades 62 is spaced a first distance from the second surface 34b and a second distance from the bottom 54 of the skirt 38. In some examples, the first distance can be greater than the second distance, in other examples, the first distance can be less than the second distance, and in yet other examples the first distance can be equal to the second distance. Thus, the first distance and the second distance can be varied depending on the environment the sweeper head 14 is used in and the type of chip that is to be swept up the sweeper head 14.

Additionally, the set of blades 62 may be positioned such that the set of blades 62 is proximate at least one barb 74 that extends from an internal surface 78 of the skirt 38. For example, the at least one barb 74 can be disposed above or below the set of blades 62. In other examples, such as the example depicted in FIG. 4, the height of the set of blades 62 can be a height such that a first set barbs 74 is disposed above the set of blades 62 and a second set of barbs 74 is disposed below the set of blades 62. In such an example, the first and second set of barbs 74, in conjunction with the set of blades 62, can untangle stringy, bunched up chips as well as size chips to permit the passage of some chips while preventing the passage of other chips to the aperture 42. Moreover, each of the at least one barb 74 extends from the internal surface 78 of the skirt 38, such that, at least a portion of each of the at least one barb 74 extends past the tip of the at least one blade 70 in the set of blades 62. In such an example, the at least one barb 74 can extend radially inward from the internal surface 78 of the skirt 38 following a linear path. However, in other examples, the at least one barb 74 can extend radially inward from the internal surface 78 of the skirt 38 following a curved path. In such an example, the at least one barb 74 would preferably extend from the internal surface 78 of the skirt 38 such that the curved path follows the direction of rotation of the set of blades 62, e.g., when the set of blades 62 rotates clockwise, the at least one barb 74 curves in a clockwise path from the internal surface 78; when the set of blades 62 rotates counterclockwise, the at least one barb 74 curves in a counterclockwise path from the internal surface 78.

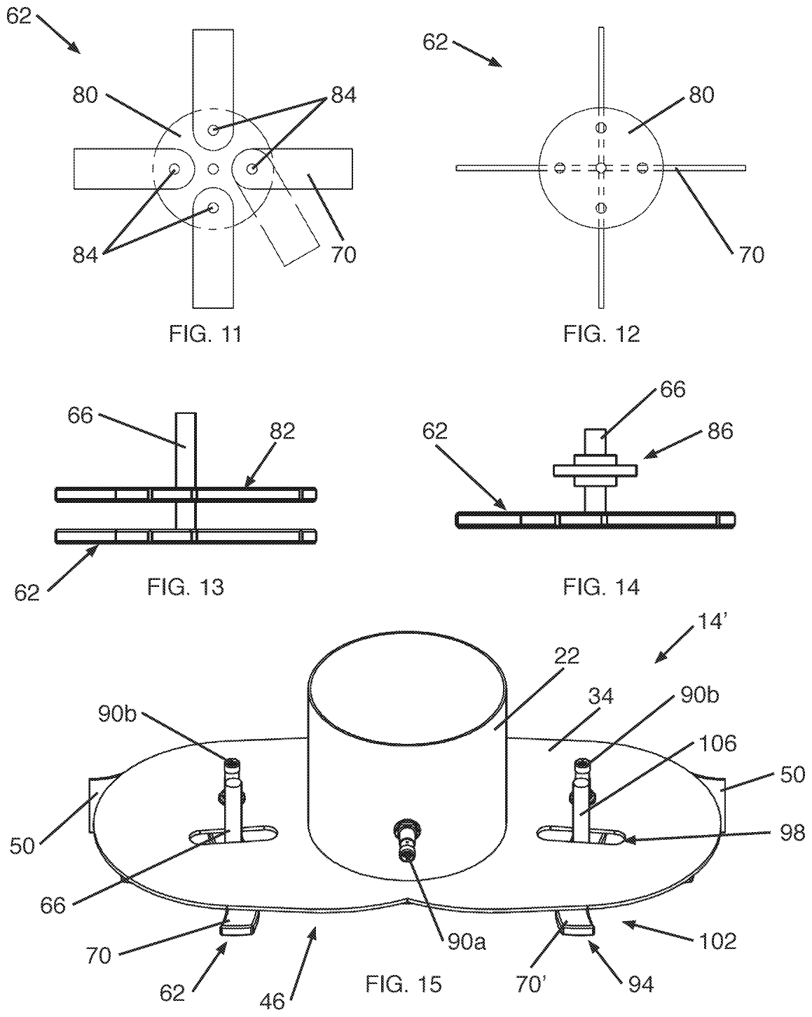

Each blade 70 in the set of blades 62 is shaped such that when the set of blades 62 rotates, the set of blades 62 bring at least one chip through the opening 46 and toward the aperture 42. To this end, the set of blades 62 may take any shape and size, and include any number of blades 70 in the set of blades 62. For example, the set of blades 62 can include 1, 2, 3, 4, etc. individual blades 70 in the set of blades 62. FIGS. 7-12 illustrate various examples of different shapes that the blades 70 in the set of blades 62 can take. For example, FIG. 7 illustrates a set of blades 62 where the blades 70 generally form a “T” shape, but each of the blades 70 in the set of blades 62 is curved. In such an example, each blade 70 in the set of blades 62 are equally spaced from one another such that the blades 70 form a symmetrical pattern. FIG. 8 illustrates a set of blades 62 that is similar to the set of blades 62 illustrated in FIG. 7, but is different in that each blade is substantially linear. FIGS. 9 and 10 illustrate other examples of sets of blades 62 that have an asymmetrical layout of each of the blades 70 in the set of blades 62. FIG. 11 illustrates another example of the set of blades 62 where each blade 70 is fixed to a central hub 80 such that each blade 70 can move independent of the central hub 80. In such an example, each blade 70 in the set of blades 62 can rotate relative to the central hub 80 about a pivot 84 that fixedly attached each blade to the central hub 80. FIG. 12 illustrates yet another example of the set of blades 62 where each blade 70 extends outwardly from a central axis of a central hub 80. In such an example, each blade 70 in the set of blades 62 can be a flexible monofilament line. Additionally, in some examples, each blade 70 in the set of blades 62 can include a brush 72 that extends from a surface of at least one blade 70 toward the bottom 54 of the skirt 38. Depending on the height of the set of blades 62, the brush 72 can extend past the bottom 54 of the skirt 38, in some examples, or can extend up to the bottom 54 of the skirt 38, in other examples.

In some examples, each blade 70 in the set of blades 62 can include a tip made of a material that is stronger (i.e., has a greater material hardness) than the material used to make each blade 70, which allows each blade 70 in the set of blades 62 to more accurately cut and size chips. For example, the tip of the blade 70 can be made of carbide and integrally formed with the blade 70. In other examples, a carbide insert can be releasably attached to the tip of each blade 70 in the set of blades 62. In such an example, the carbide insert extends longitudinally into the blade 70 to anchor the carbide insert and can be attached to the tip using any appropriate attachment mechanism, such as, for example, friction fit, adhesive, tongue and groove, threaded fastener, etc. The carbide insert allows for quick replacement of the carbide tip, which may lead to less down time for maintenance. Any carbide can be used, such as, for example, tungsten carbide or titanium carbide.

The sweeper mechanism 26, in some examples can also include an additional set of blades 82 mounted to the shaft 66. In such an example, the additional set of blades 82 can be mounted above the set of blades 62, as depicted in FIG. 13, or below the set of blades 62, provided the shaft 66 extends past the set of blades 62. The additional set of blades 82 may take any shape and may include any number of individual blades 70 in the additional set of blades 82. For example, the additional set of blades 82 can be the same shape and include the same number of individual blades 70 in the additional set of blades 82 as the shape and number of individual blades 70 in the set of blades 62. In other examples, the additional set of blades 82 can be a different shape and include a different number of individual blades 70 in the additional set of blades 82 than the shape and number of individual blades 70 in the set of blades 62. Further, the sweeper mechanism 26 can include a clutch 86 disposed on the shaft 66 in some examples. The clutch 86 may be any clutch suitable for the specific application of the sweeper head 14. For example, the clutch 86 can be a friction disk type clutch. In such an example, the clutch 86 can be placed on the shaft 66 such that the set of blades 62 is disposed between fibrous friction disks. A cup spring would apply clamping pressure to the friction disks, such that an ever increasing load would be required before the set of blades 62 stalls.

Additionally, the sweeper head 14 includes at least one sensor 90 for measuring or detecting various parameters during use of the sweeper head 14. In particular, a first sensor 90a may be disposed on the sweeper head 14 such that the first sensor 90a measures the fluid flow through the hose 22. For example, the first sensor 90a can be placed through the connector 30 such that an end of the first sensor 90a is disposed within the hose 22. The first sensor 90a may be any sensor capable of detecting fluid flow. In particular, in some examples, the first sensor 90a can be a vacuum sensor. In such an example, the first sensor 90a can detect if a measured air flow rate is below, equal to, or greater than a predetermine air flow rate. If the first sensor 90a measures an air flow rate that is below or greater than a predetermined air flow rate, the sensor can transmit a fault signal to the control module 60. In some examples, the fault signal can be displayed on the user interface 63 of the control module 60 and/or transmitted to the machining center or mill. The control module 60 can, in some examples, transmit a stop signal to the vacuum generator 18 to turn off the vacuum generator 18 until the issue causing the fault signal is resolved. The vacuum generator 18 can be turned on automatically by the control module 60, in some examples, or can be manually turned on, in other examples, when the issue causing the fault signal is resolved. Additionally, in some examples, the first sensor 90a can transmit the measured air flow rate to the control module 60, which, in turn, can display the measured air flow rate on the user interface 63.

A second sensor 90b is disposed on the sweeper head 14 such that the second sensor 90b detects when the sweeper mechanism 26, and in particular the set of blades 62, is jammed. For example, the second sensor 90b can be disposed through the plate 34 and proximate the set of blades 62, as depicted in FIGS. 4 and 5. The second sensor 90b may be any type of sensor capable of detecting a distance between certain objects and the second sensor 90b. For example, the second sensor 90b can be a proximity switch and, in particular, a proximity switch capable of storing an interval at which at least one object passes the second sensor 90b during normal operation and comparing a measured interval at which the at least one object passes the second sensor 90b to the stored interval. For the purposes of the discussion of the second sensor 90b, “normal operation” means unimpeded rotation of the sweeper mechanism. For example, each blade 70 in the set of blades 62 passes the second sensor 90b at an interval during normal operation. The interval is stored in a memory of the proximity sensor to be later used as a baseline when comparing and determining if a measured interval is substantially equal to the previously stored interval. If the measured interval is greater than or less than the stored interval, then the second sensor 90b can transmit a remedial signal to the control module 60 causing the control module 60 to execute logic that corrects the disparity between the measured interval and the stored interval. For example, the control module 60 can execute a jam clearing logic that, when executed, causes the set of blades 62 to rotate in a direction opposite the operational direction of rotation to clear any chips that may have caused the set of blades 62 to jam. In other examples, the control module 60 can execute a power down logic that, when executed, causes the set of blades 62 to stop rotating. The power down logic can be executed when the second sensor 90b detects that the measured interval is greater than or less than the stored interval. In other examples, the control module 60 can execute the power down logic when execution of the jam clearing logic fails to return the set of blades 62 to normal operation.

Finally, FIG. 14 illustrates another example of a sweeper head 14′, constructed in accordance with the present disclosure, that is similar to the sweeper head 14 illustrated in FIGS. 2-5, with common components illustrated using common reference numerals, but differs in that the sweeper head 14′, unlike sweeper head 14, includes an additional sweeper mechanism 94. Like the sweeper head 14, the sweeper head 14′ includes a sweeper mechanism 26, a connector 30 configured to be coupled to the hose 22, a horizontal plate 34, a skirt 38 that extends transversely from the plate 34, and an aperture 42 that extends through the plate 34 and is in communication with the connector 30, but differs in that the sweeper head 14′ includes the additional sweeper mechanism 94. In particular, the additional sweeper mechanism 94 includes an additional drive 98 disposed on the first surface 34a of the plate 34, an additional set of blades 102 disposed below the second surface 34b of the plate 34, and an additional shaft 106 that operatively couples the additional drive 98 and the additional set of blades 102.

The set of blades 62 and the additional set of blades 102 may be disposed on the plate 34 in any manner such that a portion of each blade 70 in the set of blades 62 and a portion of each blade 70′ in the additional set of blades 102 extends past the perimeter of the plate 34 at the opening 46. For example, as illustrated in FIG. 14, the set of blades 62 and the additional set of blades 102 are disposed on either side of the connector 30.

Those skilled in the art will recognize that a wide variety of modifications, alterations, and combinations can be made with respect to the above described examples without departing from the scope of the disclosure, and that such modifications, alterations, and combinations are to be viewed as being within the ambit of the inventive concept.

We claim:

1. A free-floating, sweeper head for a pneumatic chip collector, the sweeper head comprising:
a sweeper mechanism; and
a connector configured to be coupled to a pneumatic system;
the sweeper head having a horizontal plate including a first surface and a second surface opposite the first surface, a skirt that extends transversely from the second surface of the plate along a portion of a perimeter of the plate, and an aperture that extends through the plate and is in communication with the connector; and
the sweeper mechanism having a drive disposed on the first surface of the plate, a set of blades disposed below the second surface of the plate, and a shaft operatively coupling the drive and the set of blades,
wherein the skirt creates an opening adapted to receive at least one chip when the set of blades is rotated.

2. The sweeper head of claim 1, wherein a portion of each blade in the set of blades extends past the perimeter of the plate through the opening.

3. The sweeper head of claim 1, wherein the set of blades is disposed on the plate such that a portion of each blade in the set of blades extends past a perimeter of the aperture, toward a center of the aperture.

4. The sweeper head of claim 1, wherein the set of blades is disposed on the plate such that an outer tip of each blade in the set of blades extends to a perimeter of the aperture.

5. The sweeper head of claim 1, wherein a central axis of the sweeper mechanism is offset from a central axis of the aperture.

6. The sweeper head of claim 1, wherein at least one end of the skirt is flanged to extend beyond the perimeter of the plate, adjacent the opening.

7. The sweeper head of claim 1, further comprising at least one barb disposed on an internal surface of the skirt, proximate the set of blades.

8. The sweeper head of claim 1, wherein the opening created by the skirt is a substantial opening.

9. The sweeper head of claim 1, wherein the skirt extends below the set of blades.

10. The sweeper head of claim 1, wherein the skirt extends along the perimeter of the plate proximate the aperture.

11. The sweeper head of claim 1, wherein the connector is coupled to a hose that is coupled to a vacuum generator, the vacuum generator having an operational state in which a negative pressure is generated at the aperture.

12. The sweeper head of claim 11, further comprising a rotary drive coupled to the connector and configured to rotate the head relative to the hose.

13. The sweeper head of claim 1, further comprising a sensor disposed proximate the sweeper mechanism and configured to transmit a signal when the sweeper mechanism jams.

14. The sweeper head of claim 1, further comprising a slot disposed in the plate and adapted to receive the shaft such that the position of the sweeper mechanism, relative to the plate, is adjustable.

15. The sweeper head of claim 1, wherein a height of the set of blades, relative to a bottom of the skirt, is adjustable.

16. The sweeper head of claim 1, wherein the set of blades comprises four blades.

17. The sweeper head of claim 1, wherein the sweeper mechanism further comprises an additional set of blades coaxially mounted on the shaft.

18. The sweeper head of claim 1, further comprising an additional sweeper mechanism, the additional sweeper mechanism comprising:
an additional drive disposed on the first surface of the plate, an additional set of blades disposed below the second surface of the plate, and an additional shaft operatively coupling the additional drive and the additional set of blades.

19. A pneumatic chip collector system, comprising:
a vacuum generator coupled to a first end of a hose and configured to create a negative pressure in the hose; and
a free-floating, sweeper head coupled to a second end of the hose, the sweeper head comprising:
a sweeper mechanism; and
a connector configured to be coupled to the hose;
the sweeper head having a horizontal plate including a first surface and a second surface opposite the first surface, a skirt that extends transversely from the second surface of the plate along a portion of a perimeter of the plate, and an aperture that extends through the plate and is in communication with the connector such that the negative pressure created in the hose creates a vacuum at the aperture;
the sweeper mechanism having a drive disposed on the first surface of the plate, a set of blades disposed below the second surface of the plate, and a shaft operatively coupling the drive and the set of blades, and
wherein the skirt creates an opening adapted to receive at least one chip when the set of blades is rotated.

20. The pneumatic chip collector system of claim 19, wherein a portion of each blade in the set of blades extends past the perimeter of the plate through the opening.

21. The pneumatic chip collector system of claim 19, wherein the set of blades is disposed on the plate such that a portion of each blade in the set of blades extends past a perimeter of the aperture, toward a center of the aperture.

22. The pneumatic chip collector system of claim 19, wherein the set of blades is disposed on the plate such that an outer tip of each blade in the set of blades extends to a perimeter of the aperture.

23. The pneumatic chip collector system of claim 19, wherein a central axis of the sweeper mechanism is offset from a central axis of the aperture.

24. The pneumatic chip collector system of claim 19, wherein the opening created by the skirt is a substantial opening.

25. The pneumatic chip collector system of claim 19, wherein at least one end of the skirt is flanged to extend beyond the perimeter of the plate, adjacent to the opening.

26. The pneumatic chip collector system of claim 19, further comprising at least one barb disposed on an internal surface of the skirt and proximate the set of blades.

27. The pneumatic chip collector system of claim 19, further comprising a rotary drive coupled to the connector and configured to rotate the sweeper head relative to the hose.

28. A method of collecting chips from a machining operation, the method comprising:
disposing a free-floating, sweeper head on a surface, the sweeper heading having a sweeper mechanism and a connector configured to be coupled to a pneumatic system, the sweeper head having a horizontal plate having a first surface and a second surface, a skirt that extends transversely from the second surface of the plate along a portion of a perimeter of the plate, and an aperture that extends through the plate and is in communication with the connector, the sweeper mechanism having a drive disposed on the first surface of the plate, a set of blades disposed below the second surface of the plate, and a shaft operatively coupling the drive and the set of blades;
rotating the set of blades via the drive such that at least one chip is received at the aperture through an opening created by the skirt;
generating a vacuum at the aperture; and
moving at least one of the sweeper head and the surface relative to the other.

29. The method of claim 28, further comprising suspending the sweeper head from an end of a hose connected to a pneumatic system.

30. The method of claim 29, further comprising rotating the sweeper head relative to the hose via a rotary drive operatively coupled to the hose and the connector.
